(19) United States
(12) Patent Application Publication
(10) Pub. No.: US 2007/0240058 A1
(43) Pub. Date: Oct. 11, 2007

(54) METHOD AND APPARATUS FOR DISPLAYING MULTIPLE FRAMES ON A DISPLAY SCREEN

(76) Inventor: Ming-Jun CHEN, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/279,118

(22) Filed: Apr. 10, 2006

(51) Int. Cl. H04N 5/44

(52) U.S. Cl. 715/716

(57) ABSTRACT

A playback method includes receiving input image data, displaying a main program based on the input image data on a main frame of the display screen, receiving a command corresponding to an index point which indicates a predetermined event type in the input image data, displaying information of a sub-program corresponding to the index point of the input image data on a sub-frame of the display screen, receiving a command selecting the sub-program displayed on the sub-frame, and after receiving the command selecting the sub-program, displaying information of the sub-program on the main frame.

### BACKGROUND OF THE INVENTION

1. Field of the Invention

The present invention relates to a display method and apparatus, and more particularly, to a display method and apparatus for displaying multiple frames on a display screen.

2. Description of the Prior Art

As multimedia technology advances and user requirements increase, many companies are designing different multimedia processing devices and software such as multimedia playback devices capable of recording programs received from a remote station. Using these devices, in addition to watching an already recorded program from the beginning, the user can start from various sections of the recorded program or perform other playback controls.

Common playback functions of a display device include play/pause, stop, forward/backward, fast forward/fast backward, etc. However, these specific playback functions cannot fully satisfy user requirements. For example, a DVD playback device displays a program comprising variously sized program portions usually called “chapters”. Unlike traditional analog VHS (video home system) tapes in which the play or playback operations are only provided sequentially in two directions (forward/backward), the user can begin playing the program stored in a DVD from different chapters arbitrarily. However in prior art DVD playback devices, the content of a chapter is always displayed from the beginning when selected. The user still has to manually perform forward/backward operations to search for a specific scene in the selected chapter. Besides, if the user does not have any pre-knowledge of which chapter contains the specific scene, the whole searching process can be extended to the entire program, making it more time-consuming and less efficient.

Consequently, a need exists for more efficient multimedia display methods and apparatus.

### SUMMARY OF THE INVENTION

The claimed invention discloses a method for displaying multiple frames on a display screen comprising receiving input image data; displaying a first program based on the input image data on a first frame of the display screen; setting a playback point in the first program; receiving a command corresponding to an index point which indicates a predetermined event type in the input image data; displaying information of a second program corresponding to the index point of the input image data on a second frame of the display screen; receiving a command selecting the second program displayed on the second frame; and after receiving the command selecting the second program, displaying information of the second program on the first frame of the display screen.

The claimed invention also discloses a multimedia display system capable displaying multiple frames on a display screen comprising a display panel for displaying images; a decoder for decoding input image data; an analyzer coupled to the decoder for providing the input image data with index points corresponding to different event types; a metadata database storage unit coupled to the analyzer for storing the index points and event information corresponding to the index points; and a playback controller coupled to the display panel, the decoder and the storage unit for generating output image data based on the decoded input image data provided by the decoder and the event information stored in the metadata database storage unit.

The claimed invention also discloses a computer readable medium having a program for displaying multiple frames on a display screen, comprising means for decoding input image data, means for providing the input image data with index points corresponding to different event types, means for storing the index points and event information corresponding to the index points, and means for generating output image data based on the decoded input image data and the event information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a display method according to a first embodiment of the present invention.

FIG. 2 is a diagram illustrating the result after performing steps 110-150 in FIG. 1.

FIG. 3 is a diagram illustrating the result after performing steps 110-160 in FIG. 1.

FIG. 4 is a flowchart illustrating a display method according to a second embodiment of the present invention.

FIG. 5 is a diagram illustrating the result after performing steps 410-490 in FIG. 4.

FIG. 6 is a functional diagram of a display system according to the present invention.

### DETAILED DESCRIPTION

In the present invention, images are provided with information (hereafter referred to as index points) corresponding to particular events, scenes, subjects or the like (hereafter referred to as event types) for convenience of retrieving, reviewing, and re-ordering of the images. In normal viewing operations, a main program is displayed on a main frame of a display screen according to the chronological order of the original images. When receiving a command selecting a certain index point, information of sub-programs that correspond to a particular event type as indicated by the index point is displayed on multiple sub-frames of the display screen. If one of these sub-programs is selected for more detailed information, information of the selected sub-program will then be displayed on the main frame, while information of the main program or another sub-program will be moved to the sub-frame on which information of the selected sub-program was previously displayed. Then the user can view or edit the selected sub-program. Afterwards, the user can either select another sub-program or resume playing the main program on the main frame of the display screen.

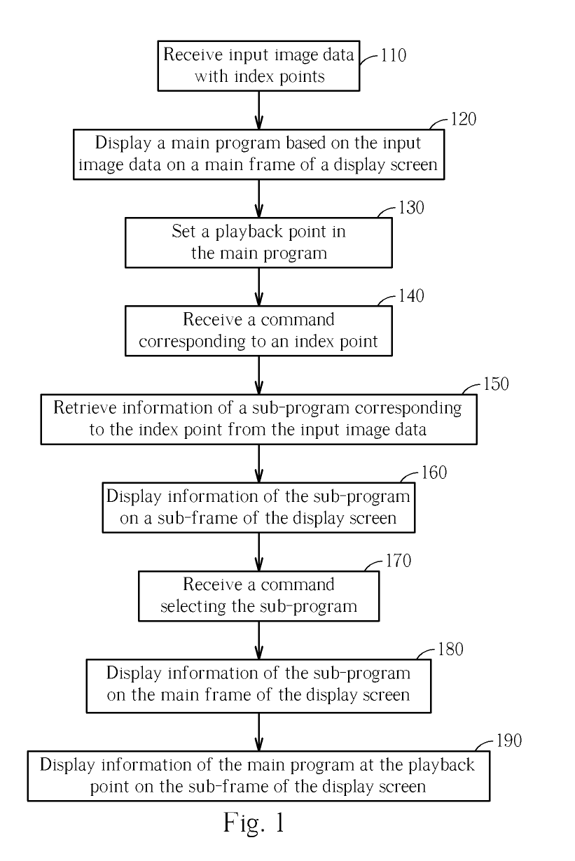

FIG. 1 shows a flowchart illustrating a display method according to a first embodiment of the present invention. The flowchart in FIG. 1 includes the following steps:

Step 110: receive input image data with index points;

Step 120: display a main program based on the input image data on a main frame of a display screen;

Step 130: set a playback point in the main program;

Step 140: receive a command corresponding to an index point indicating a predetermined event type in the input image data;

Step 150: retrieve information of a sub-program corresponding to the index point from the input image data;

Step 160: display information of the sub-program on a sub-frame of the display screen;

Step 170: receive a command selecting the sub-program with information displayed on the sub-frame;

Step 180: display information of the sub-program on the main frame of the display screen; and

Step 190: display information of the main program at the playback point on the sub-frame of the display screen.

In step 110, input image data with index points is sent to a display system. These index points correspond to particular events, scenes or subjects, such as crowd applause, exhilarating speeches, close-up shots, shot changes or commercial insertions, etc. There are various methods for analyzing the input image data and thus providing index points at corresponding data segments.

In step 120, after receiving the input image data, a main program based on the input image data is displayed on a main frame of a display screen. Usually, the main program proceeds by displaying the input image data in the chronological order, and the main frame is the entire display screen or a major portion of the display screen.

In step 130, a playback point is set in the main program. The playback point can be viewed as a reference point in the playback operation.

In step 140, while displaying the main program on the main frame, a user can search for a certain event type in the main program by entering a command corresponding to an index point of the designated event type in the input image data.

In step 150, after receiving the command entered in step 140, the display system searches in the input image data for the index point and retrieves information of at least one sub-program corresponding to the index point from the input image data. The information of a sub-program can have different formats, such as a video clip having a predetermined length, a text annotation describing the selected event type, or a video clip with corresponding text annotation, etc. For example, if the designated index point corresponds to the event type “commercial insertion”, information of a related sub-program retrieved in step 150 can be a 10-second video clip starting at where the designated index point is set, together with a text annotation labeling “commercial insertion at play time 15 min 21 sec”.

In step 160, information of the retrieved sub-program is displayed on a sub-frame of the display screen without interrupting the main program currently displayed on the main frame. The sub-frame, usually smaller than the main frame, can be a picture-in-picture (PIP) frame or a picture-on-picture (POP) frame. Other display techniques can also be used as long as the main frame and the sub-frame can display images simultaneously on the display screen. If the input image data contains more than one index point corresponding to the designated event type, multiple sub-frames can be displayed simultaneously on the display screen.

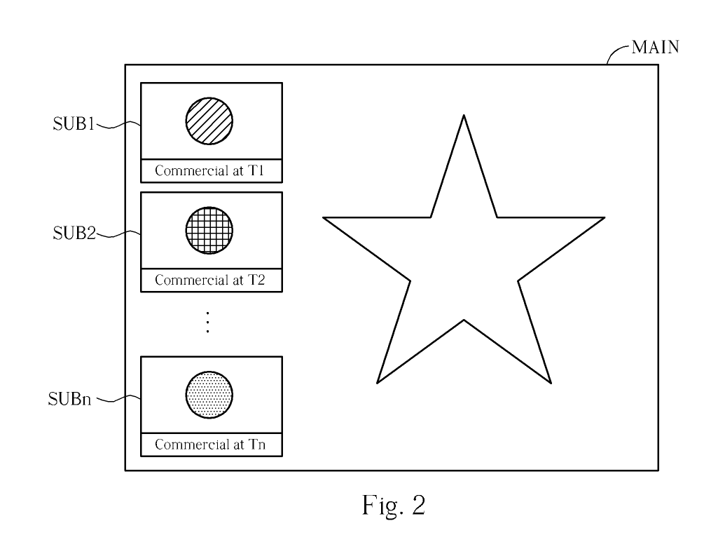

Please refer to FIG. 2 for a diagram illustrating the result after performing steps 110-160. For example, assuming the index point corresponding to the event type “commercial insertion” is inputted in step 140, and information of n sub-programs related to the “commercial insertion” index point is retrieved in step 150. In FIG. 2, information of the retrieved sub-programs (represented by various circle patterns in FIG. 2) are displayed on sub-frames SUB1-SUBn, and the main program (represented by a star pattern in FIG. 2) is displayed on a main frame MAIN. In this embodiment, information of the sub-programs displayed on the sub-frames SUB1-SUBn comprise video clips together with text annotations labeling “Commercial at T1” to “Commercial at Tn”, respectively. T1-Tn represent the location of each “commercial insertion” index point in the input image data on a timing basis. Each of the video clips can be displayed as a snapshot image at the exact location where each corresponding index point of “commercial insertion” is set. Or, the video clips can also be broadcast as continuous images starting from the locations of the corresponding “commercial insertion” index points. After playing the entire duration of the video clips without receiving further commands, the same continuous images or the snapshot images can be displayed on the sub-frames SUB1-SUBn again. Therefore, with the video clips and corresponding text annotations, the user can easily grasp the content of each sub-program. Also, in the embodiment shown in FIG. 2, the sub-frames SUB1-SUBn are PIP frames shown on the left side of the display screen. However, they can also be arranged on other locations of the display screen, as well as have other formats, such as POP frames. In addition, if the input image data contains more than n index points corresponding to the event type “commercial insertion”, only information of n sub-programs can be displayed simultaneously on the sub-frames SUB1-SUBn of the display screen. In the first embodiment of the present invention, information of the sub-programs having “commercial insertion” index points nearest to the playback point set in step 130 is displayed according to their chronological orders. For example, among T1-Tn, T1 can be the nearest “commercial insertion” index point with respect to the current playback point, while Tn is the furthest “commercial insertion” index point with respect to the current playback point, or vice versa. Or, T(n/2), assuming n/2 is an integral number, can be the nearest “commercial insertion” index point with respect to the current playback point, while T1 and Tn are the furthest “commercial insertion” index points with respect to the current playback point.

In step 170, a command selecting the sub-program with information displayed on the sub-frame of the display screen is entered when the user wants to have a larger view of the selected sub-program. Then in steps 180 and 190, the main program and the selected sub-program switch frames; that is, information of the selected sub-program is displayed on the main frame MAIN and information of the main program is displayed on the sub-frame on which information of the selected sub-program was previously shown.

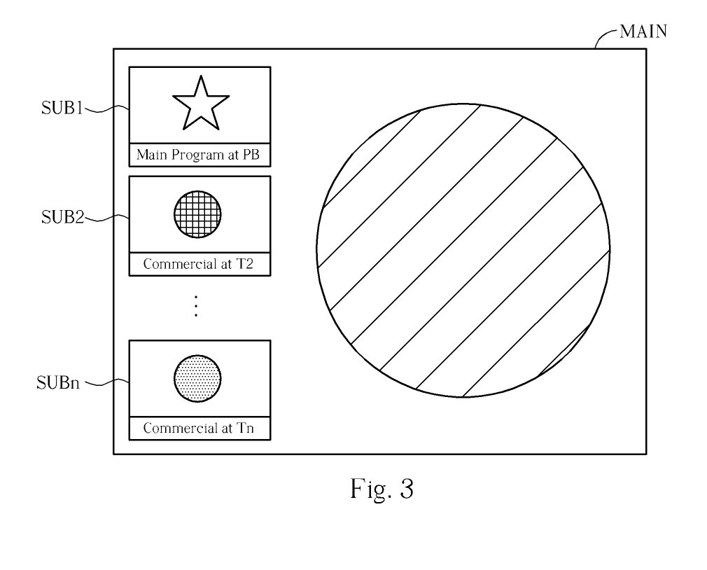

Please refer to FIG. 3 for a diagram illustrating the result after performing steps 110-190. For example, assuming the index point corresponding to the event type “commercial insertion” is inputted in step 140, information of n sub-programs related to the “commercial insertion” index point is retrieved in step 150, and a first sub-program with information displayed on the sub-frame SUB1 in step 160 is selected in step 170. In FIG. 3, information of the selected first sub-program is now displayed on the main frame MAIN, while information of the main program is now displayed on the sub-frame SUB1 at the playback point. In this embodiment, information of the main program displayed on the sub-frames SUB1 also comprises a text annotation labeling “Main Program at PB”, where PB represents the current playback point set in step 130.

After the steps shown in FIG. 1, the user can view, edit or process the first sub-program displayed on the main frame MAIN of the display screen. Then, the user can choose to play another sub-program or resume playing the main program on the main frame MAIN of the display screen. When receiving a command selecting the main program with corresponding information displayed on the sub-frame SUB1, the main program is displayed on the main frame MAIN of the display screen starting from the playback point PB, and then information of the first sub-program is again displayed on the sub-frame SUB1 of the display screen. When receiving a command selecting another sub-program, such as a second sub-program with information displayed on the sub-frame SUB2, the first and second sub-programs switch frames; that is, information of the second sub-program is displayed on the main frame MAIN of the display screen and information of the first sub-program is displayed on the second sub-frame SUB2 of the display screen. Therefore, the user can then view or edit the second sub-program displayed on the main frame MAIN of the display screen.

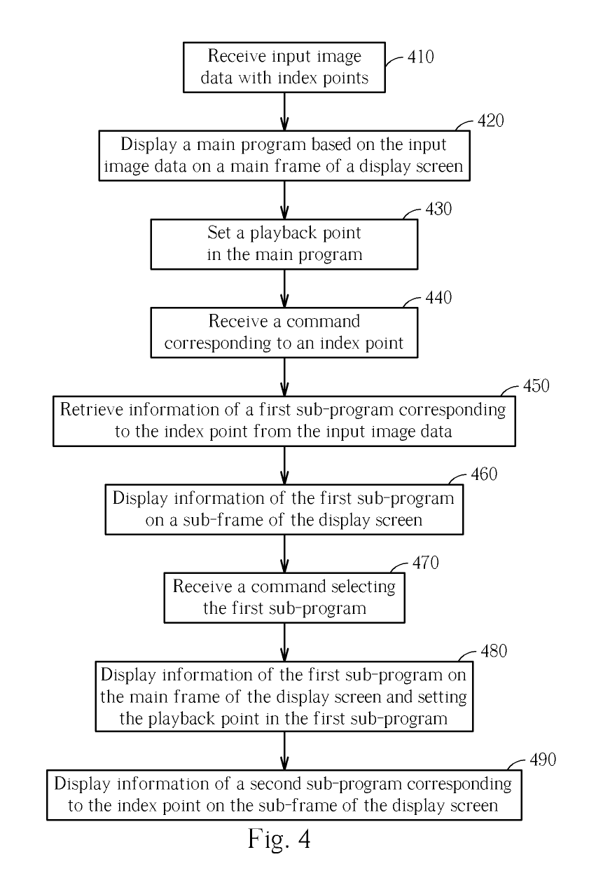

FIG. 4 shows a flowchart illustrating a display method according to a second embodiment of the present invention. The flowchart in FIG. 4 includes the following steps:

Step 410: receive input image data with index points;

Step 420: display a main program based on the input image data on a main frame of a display screen;

Step 430: set a playback point in the main program;

Step 440: receive a command corresponding to an index point indicating a predetermined event type in the input image data;

Step 450: retrieve information of a first sub-program corresponding to the index point from the input image data;

Step 460: display information of the first sub-program on a sub-frame of the display screen;

Step 470: receive a command selecting the first sub-program with information displayed on the sub-frame;

Step 480: display information of the first sub-program on the main frame of the display screen and setting the playback point in the first sub-program; and

Step 490: display information of a second sub-program corresponding to the index point on the sub-frame of the display screen.

Steps 410-470 of the second embodiment are similar to steps 110-170 of the first embodiment shown in FIG. 1. After steps 410-460, information of the first sub-program is displayed on a sub-frame of the display screen without interrupting the main program currently displayed on the main frame. The diagram shown in FIG. 2 can also illustrate the result after performing steps 410-460, in which the command corresponding to the “commercial insertion” index point is inputted in step 440, information of the sub-programs related to the “commercial insertion” index point is retrieved in step 450 and respectively displayed on the sub-frames SUB1-SUBn in step 460. Also, the playback point is set in the first sub-program in step 480 after the command selecting the first sub-program is entered. After steps 410-480, the user can view or edit the selected first sub-program displayed on the main frame MAIN of the display screen. In step 490, the sub-frame on which information of the first sub-frame was previously shown can now be used for displaying information of a second sub-program corresponding to the index point.

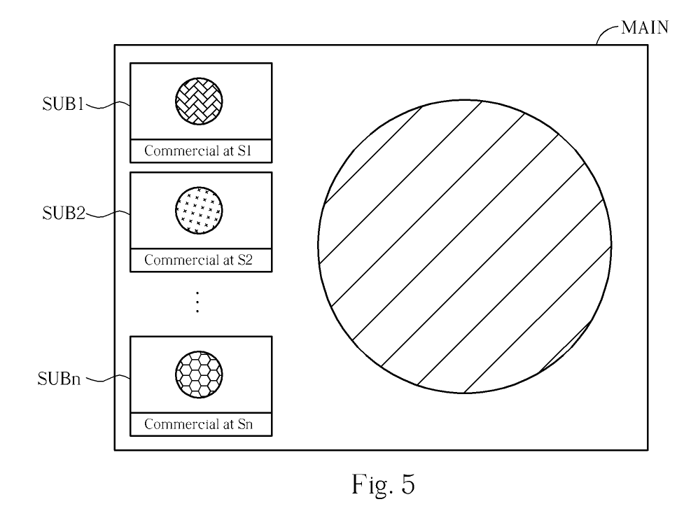

Please refer to FIG. 5 for a diagram illustrating the result after performing steps 410-490 of the second embodiment. For example, assuming the command corresponding to the index point “commercial insertion” is inputted in step 440, information of the sub-programs related to the “commercial insertion” index point is retrieved in step 450 and respectively displayed on the sub-frames SUB1-SUBn in step 460, and a first sub-program with information displayed on the sub-frame SUB1 in step 460 is selected in step 470. In the second embodiment of the present invention, information of the sub-programs having “commercial insertion” index points nearest to the playback point set in step 430 is displayed on the sub-frames SUB1-SUBn according to their chronological orders.

Step 490 can be viewed as frame rearrangement. After the playback point is updated and information of the first sub-program is displayed on the main frame MAIN, information of the sub-programs having “commercial insertion” index points nearest to the current playback point set in step 480 is displayed on the sub-frames SUB1-SUBn according to their chronological orders. As shown in FIG. 5, information of the sub-programs comprising video clips (represented by various circle patterns in FIG. 4) together with text annotations labeling “Commercial at S1” to “Commercial at Sn” is now displayed on the sub-frame SUB1-SUBn, respectively. S1-Sn represent the location of each “commercial insertion” index point in the input image data on a timing basis, and are nearest to the current playback point set in step 480.

The steps illustrated in FIG. 1 and FIG. 4 can be applied in various occasions such as retrieving, reviewing, re-ordering, or deleting images of different event types. For example, when the user wants to delete all commercials in a program, a command corresponding to the index point “commercial insertion” is entered. All associated data can then be extracted and displayed on the sub-frames of the display screen together with the main program. The user no longer needs to search manually for each commercial in the entire program.

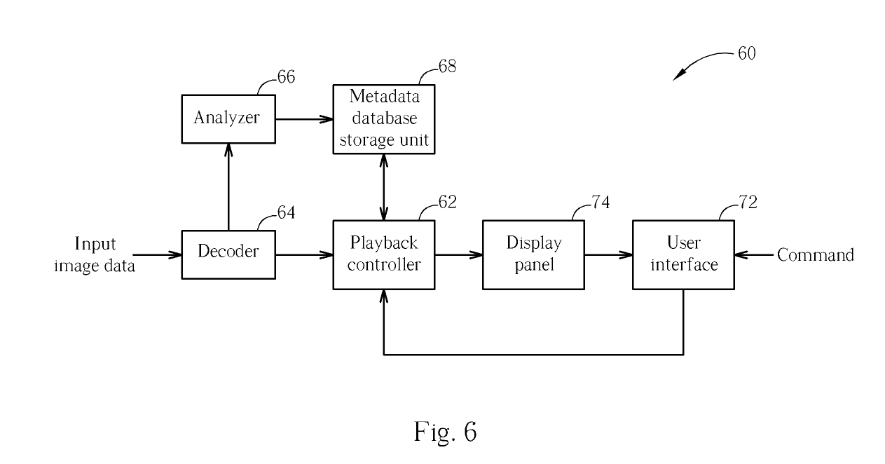

FIG. 6 shows a functional diagram of a display system 60 according to the present invention. The display system 60 includes a playback controller 62, a decoder 64, an analyzer 66, a metadata database storage unit 68, a user interface 72, and a display panel 74. The decoder 64 receives and decodes input image data, and sends the decoded input image data to the analyzer 66 and the playback controller 62. The analyzer 66 analyzes the decoded input image data for generating index points related to different event types at corresponding locations in the input image data. The metadata database storage unit 68 is coupled to the analyzer 66 for storing the index points and event information corresponding to the index points. In normal viewing operations, the playback controller 62 sends the decoded input image data generated by the decoder 64 to the display panel 74 where corresponding images can thus be displayed. When searching for images of a certain event type, the user enters a command corresponding an index point of the designated event type to the playback controller 62 via the user interface 72. Upon receiving the command from the user, the playback controller 62 accesses corresponding index points and event information stored in the metadata database storage unit 68. Then the retrieved event information is sent to the display panel 74 and displayed as described in the methods shown in FIG. 1 or FIG. 4.

The present invention provides methods and devices capable of displaying multiple frames on a display screen. Input image data are provided with index points corresponding to various event types. When receiving a command selecting a certain index point related to a particular event type, corresponding sub-programs are displayed on multiple sub-frames of the display screen. Then the user can choose to display these sub-programs on the main frame of the display screen for viewing, editing, or image processing. Therefore in the present invention, images corresponding to different event types can be extracted efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying multiple frames on a display screen comprising:
receiving input image data;
displaying a first program based on the input image data on a first frame of the display screen;
setting a playback point in the first program;
receiving a command corresponding to an index point which indicates a predetermined event type in the input image data;
displaying information of a second program corresponding to the index point of the input image data on a second frame of the display screen;
receiving a command selecting the second program displayed on the second frame; and
after receiving the command selecting the second program, displaying information of the second program on the first frame of the display screen.

2. The method of claim 1 further comprising:
after receiving the command selecting the second program, displaying information of the first program at the playback point on the second frame of the display screen.

3. The method of claim 2 further comprising:
after receiving a command selecting the first program displayed on the second frame, resuming displaying the first program from the playback point on the first frame of the display screen and displaying information of the second program on the second frame of the display screen.

4. The method of claim 2 further comprising:
after receiving a command selecting a third program corresponding to the index point of the input image data, displaying information of the third program on the first frame of the display screen and displaying information of the second program on the third frame of the display screen.

5. The method of claim 1 further comprising:
after receiving the command selecting the second program, displaying information of the second program on the first frame of the display screen and displaying information of a third program corresponding to the index point of the input image data on the second frame of the display screen.

6. The method of claim 1 wherein displaying the first program based on the input image data on the first frame of the display screen is displaying a main program based on the input image data on a main frame of the display screen.

7. The method of claim 1 wherein displaying information of the second program corresponding to the index point of the input image data on the second frame of the display screen is displaying information of a sub-program corresponding to the index point of the input image data on a sub-frame of the display screen.

8. The method of claim 1 wherein displaying information of the second program corresponding to the index point of the input image data on the second frame of the display screen is displaying information of a sub-program corresponding to the index point of the input image data on a second frame of the display screen that is smaller than first frame of the display screen.

9. The method of claim 1 further comprising:
providing a user interface for entering the commands.

10. The method of claim 1 further comprising:
providing the input image data with the index point indicating the predetermined event type in the input image data.

11. The method of claim 1 further comprising:
retrieving information of the programs corresponding to the index point from the input image data.

12. The method of claim 1 further comprising:
providing a metadata database containing index points indicating predetermined event types in the input image data.

13. The method of claim 12 further comprising:
retrieving information of the second program using the metadata database.

14. The method of claim 1 wherein displaying information of the second program corresponding to the index point of the input image data on the second frame of the display screen is displaying a sub-program including a video clip corresponding to the index point of the input image data on the second frame of the display screen.

15. The method of claim 1 wherein displaying information of the second program corresponding to the index point of the input image data on the second frame of the display screen is displaying a sub-program including a text annotation corresponding to the index point of the input image data on the second frame of the display screen.

16. The method of claim 1 wherein displaying information of the second program corresponding to the index point of the input image data on the second frame of the display screen is displaying a sub-program including a video clip and a text annotation corresponding to the index point of the input image data on the second frame of the display screen.

17. The method of claim 1 wherein displaying information of the second program corresponding to the index point of the input image data on the second frame of the display screen is displaying the second program corresponding to the index point of the input image data on a picture-in-picture (PIP) frame of the display screen.

18. The method of claim 1 wherein displaying information of the second program corresponding to the index point of the input image data on the second frame of the display screen is displaying the second program corresponding to the index point of the input image data on a picture-on-picture (POP) frame of the display screen.

19. A multimedia display system capable displaying multiple frames on a display screen comprising:
a display panel for displaying images;
a decoder for decoding input image data;
an analyzer coupled to the decoder for providing the input image data with index points corresponding to different event types;
a metadata database storage unit coupled to the analyzer for storing the index points and event information corresponding to the index points; and
a playback controller coupled to the display panel, the decoder and the storage unit for generating output image data based on the decoded input image data provided by the decoder and the event information stored in the metadata database storage unit.

20. The multimedia display system of claim 18 further comprising a user interface for allowing a viewer to enter commands to the playback controller for selecting the index points.

21. A computer readable medium having a program for displaying multiple frames on a display screen, comprising:
means for decoding input image data;
means for providing the input image data with index points corresponding to different event types;
means for storing the index points and event information corresponding to the index points; and
means for generating output image data based on the decoded input image data and the event information.

22. The computer readable medium of claim 21 further comprising:
means for displaying images based on the outputted image data.

23. The computer readable medium of claim 21 further comprising:
means for entering commands selecting the index points.
